(19) United States
(12) Patent Application Publication
(10) Pub. No.: US 2018/0154546 A1
(43) Pub. Date: Jun. 7, 2018

(54) METHOD OF CONTINUOUS EDGE PROCESSING OF PLATES AND EDGE PROCESSING DEVICE

(71) Applicant: ULMADAN-R.D. ApS, Kerteminde (DK)

(72) Inventors: Uffe NØRSKOV LAURSEN, Kerteminde (DK); Tom DAHL, Silkeborg (DK)

(73) Assignee: ULMADAN-R.D. ApS, Kerteminde (DK)

(21) Appl. No.: 15/572,867

(22) PCT Filed: May 11, 2015
(86) PCT No.: PCT/IB2015/053450

§ 371 Date: Nov. 9, 2017

(51) Int. Cl. B27C 5/08; B05C 1/00; B27N 7/00

(52) U.S. Cl. CPC B27C 5/08; B27N 7/005; B05C 1/006

(57) ABSTRACT

Plates (2;) are conveyed continuously in a conveying direction, whereby at least a first edge (15) of a plate Is provided with an edge profile by means of a rotating edge milling tool. A corner (16) connecting, the first edge and a second edge (17) of the plate is rounded at least partly by means of a rotating milling tool (12a, 12b) having a peripheral profile corresponding to a desired corner edge: profile of the plate. The rotating corner milling tool is controlled to be displaced along the continuously moving plate so if) at the rotating garner milling tool moves next to a corner to: he mimdeell and Is subsequently controlled to fee displaced simultaneously in the conveying direction (D) and m a transverse direction to Hie conveying, direction so that if follows a trajectory describing at least a part of: a desired rounding of the corner in a coordinate system fixed to the continuously moving plate.

The present invention relates to a method of continuous edge processing of plates, whereby the plates are conveyed continuously in a conveying direction, and whereby at least a first edge of a plate is provided with an edge profile by means of a rotating edge milling tool having a peripheral profile corresponding to a desired edge profile of the plate.

DE 10 3013 202 007 A1 discloses a device for providing untreated narrow sides of wooden particle boards for surface treatment. A floating roller and conveying belt conveys a board linearly and continuously in a flow path. A grinding and cleaning unit performs grinding and cleaning of untreated narrow edges of the board. An applying unit coats paint on board narrow sides while a reverse roll is rotated at suitable speed. A removing unit removes excess coating from longitudinal edges and edges of painted narrow side, and a drying unit dries and cures coating film. The roll is cleaned by a paint scraper so that optimum state of roll with board narrow is maintained.

EP 1 154 891 A1 discloses a continuous process and a device for applying a coating material to porous narrow sides of work pieces. The work piece move continuously through a coating machine where a filling and bonding compound is applied to the porous narrow edge. A decorative coating strip is then pressed onto the compound and bonds to it. Independent claims are made for: a) the process plant which has a work piece conveyor, a coating unit for applying the filling and bonding compound to the narrow edge of the work piece, a continuous feeding unit for the decorative coating strip and a pressure applicator with a sliding face for pressing the coating strip onto the narrow edge; b) a work piece whose porous narrow edge is covered and levelled by the filling compound and a subsequent coating strip.

WO 99/51361 A1 (Ulmadan APS) discloses a method for application of lacquer to edges on plates and lists, especially of the porous type which are used within the furniture industry, where by changing the CAD reference dimension of the edge profile lacquer dosing unit it is possible to apply differentiated amounts of lacquer to predetermined areas. The document also discloses a system for the application of lacquer to the edges on plates and lists, especially of the porous type used in the furniture industry. Among other things, the system comprises one or more application rollers, possibly with a groove in the surface of the individual roller which can correspond to the edge profile to which the lacquer is to be applied. The CAD reference can also be changed in the profile groove of the application roller, or in both the roller and the dosing unit. By using several units or application rollers in succession, a particularly fine surface is obtained by allowing the application roller which is placed last in the direction in which the work piece is fed, to rotate in the opposite direction, whereby the excess lacquer is removed while, at the same time a very well-defined thickness of lacquer is achieved. The method and the system are especially applicable in the lacquering of chipboards and similar porous plates which are not homogeneous.

However according to the known continuous processing methods, although the edges of the plates may be provided with a rounded profile, at the corners of the plates, these rounded profiles meet in a sharp line. This is doe to the processing methods, whereby the plates are conveyed in a conveying direction on a conveyor as two opposed edges are formed by stationarily positioned milling tools, and whereby the plates are subsequently rotated 90 degrees in relation to the conveying direction and then conveyed on the conveyor as the two remaining opposed edges are formed oy the stationarily positioned milling tools. Until now, corners could not be rounded smoothly in a continuous process. Although corners could be rounded in a stationary process by means of numeric processing tools, such process cannot in any way compete with a continuous process in terms of number of processed items per time. In a continuous process, plates may be processed very fast. For instance, the plates may be processed during conveyance on a conveyor with at constant speed of approximately 25 metres per minute.

The object of the present invention is to provide a method of continuous edge processing of plates, whereby carriers of the plates may be rounded.

In view of this object, the at least a corner connecting the first edge and a second edge of the plate is rounded at least partly by means of a rotating corner milling tool having a peripheral profile corresponding to a desired corner edge profile of the plate, the rotating corner milling tool is controlled to be displaced along the continuously moving plate so that the rotating corner milling tool moves next to a corner to be rounded, and the rotating corner milling tool is subsequently controlled to be displaced simultaneously in the conveying direction and in a transverse direction to the conveying direction so that the rotating corner milling tool follows a trajectory describing at least a part of a desired rounding of the corner in a coordinate system fixed to the continuously moving plate.

In this way, the corners of a plate may he fully or partly rounded smoothly with a desired corner edge profile as the plate is conveyed continuously in the conveying direction.

In an embodiment, a control unit controls displacement of the rotating corner milling tool in the conveying direction and in a transverse direction to the conveying direction, a position and/or velocity detection device continuously detects the position and/or velocity of the plate in the conveying direction, and the control unit, on the basis of the detected position and/or velocity of the plate, controls this position of the rotating corner milling tool to follow said trajectory.

In an embodiment, the control unit calculates said trajectory as an estimated trajectory on the basis of the velocity of the plate in the conveying direction at a position of the plate in the conveying direction before the control unit starts to control the rotating corner milling tool to follow said trajectory. Thereby, the rotating corner milling tool may be controlled to follow said trajectory much faster than if the trajectory would be calculated gradually as the rotating corner milling tool follows the trajectory.

In an embodiment, the velocity of the plate in the conveying direction is determined by means of a first tachometer coupled to a conveyor continuously conveying the plates in the conveying direction. Thereby, the actual conveying velocity of the plate may be determined very accurately at a position next to the rotating corner milling tool.

In an embodiment, the velocity of the plate in the conveying direction is determined when a leading or trailing edge of the plate is detected at a certain position in the conveying direction.

In an embodiment, the leading or trailing edge of the plate is detected at said certain position by means of a first laser detection device. Thereby, the position of the plate may be determined very accurately next to the rotating corner milling tool.

In an embodiment, subsequently to rounding the corner connecting the first edge and the second edge of the plate, the first edge is provided with a layer of lacquer by means of a lacquer application roller having a peripheral profile corresponding at least substantially to the desired edge profile of the plate, the lacquer application roller, over at least almost the entire length of the first edge, rolls on the first edge of the plate with a peripheral speed corresponding at least substantially to the velocity of the plate in the conveying direction, and, when the lacquer application roller is at a position at the corner connecting the first edge and the second edge of the plate, the peripheral speed of the lacquer application roller is changed in relation to the velocity of the plate in the conveying direction so that an extra amount of lacquer is deposited at said corner. Thereby, at least a part of the corner may be provided with lacquer without the lacquer application roller having to follow the rounding of the corner. As the lacquer application roller may have a quite large diameter in relation to the rotating corner milling tool, the lacquer application roller is preferably not displaced in the transverse direction of the conveying direction (whereas the rotating corner milling tool is in fact displaced in the transverse direction as explained above). In this way, even plates having a quite small dimension in the transverse direction may be processed. As the plates may be carried on a conveyor, plates having a quite small dimension in the transverse direction may be positioned on the conveyor with their edge to be processed quite close to the conveyor.

In an embodiment, when the lacquer application roller is at a position at the corner connecting the first edge and the second edge of the plate, the peripheral speed of the lacquer application roller is changed to differ by between 2 and 25 percent, preferably by between 3 and 25 percent, more preferred by between 4 and 16 percent, even more preferred fey between 8 and 12 percent, and most preferred by between 7 and 10 percent, in relation to the velocity of the plate in the conveying direction. Thereby, it may be ensured that a suitable amount of lacquer is deposited at the corner.

In an embodiment, if the second edge is a leading edge of the plate, when the lacquer application roller is at a position at the corner connecting the first edge, and the second edge of the plate, the peripheral speed of the lacquer application roller is decreased in relation to the velocity of the plate in the conveying direction, and the second edge is a trailing edge of the plate when the lacquer application roller is at a position as the corner connecting the first edge and the second edge of the plate, the peripheral speed of the lacquer application roller is increased in relation to the velocity of the plate in the conveying direction. Thereby, it may efficiently be ensured that a suitable amount of lacquer is deposited at the corner.

In an embodiment, subsequently to application of lacquer at the corner connecting the first edge and the second edge of the plate, and subsequently to an at least partial curing of said lacquer, said corner is grinded by means of a rotating corner grinding tool having a peripheral profile corresponding to the desired corner edge profile of the plate, the rotating corner grinding tool is controlled to be displaced along the continuously moving plate so that the rotating corner grinding tool moves next to said corner, and the rotating corner grinding tool is subsequently controlled to be displaced simultaneously in the conveying direction and in a transverse direction of the conveying direction so that the rotating corner grinding tool follows a trajectory describing at least a part of the desired rounding to the corner in a coordinate system fixed to the continuously moving plate. Thereby, the extra amount of lacquer that has been deposited at said corner may be grinded correctly to follow the desired rounding of the corner.

In an embodiment a control unit controls displacement of the rotating corner grinding tool in the conveying direction and in a transverse direction to the conveying direction, a further position and/or velocity detection device continuously detects the position and/or velocity of the plate in the conveying direction, and the control unit, on the basis of the detected position and/or velocity of the plate, controls the position of the rotating corner grinding tool to follow said trajectory.

In an embodiment, the control unit calculates said trajectory as an estimated trajectory on the basis of the velocity of the plate in the conveying direction at a position of the plate in the conveying direction before the control unit starts to control the rotating corner grinding tool to follow said trajectory. Thereby, the rotating corner grinding tool may be controlled to follow said trajectory much faster than if the trajectory would be calculated gradually as the rotating corner grinding tool follows the trajectory.

In an embodiment, the velocity of the plate in the conveying direction is determined by means of a second tachometer coupled to the conveyor at a position after the position of the first tachometer in the conveying direction. Thereby, the actual conveying velocity of the plate may be determined very accurately at a position next to the rotating corner grinding tool.

In an embodiment, the velocity of the plate in the conveying direction is determined when a leading or trailing edge of the plate is detected at a certain position in the conveying direction.

In an embodiment, the leading or trailing edge of the plate is detected at said certain position by means of a second laser detection device located at a position after the position of the first laser detection device in the conveying direction. Thereby, the position of the plate may be determined very accurately next to the rotating corner grinding tool.

In an embodiment, subsequently m grinding said corner by means of a rotating corner grinding tool, the first edge of the plate and at least 50 percent of the rounding of the corner connecting the first edge and the second edge of the plate provided with a first foil strip. Thereby, a foiled smooth rounded edge may be provided.

In an embodiment, the first foil strip is pressed onto the first edge of the plate and part of the rounding of the corner by means of a number of rollers having an elastic surface. The elasticity of the rollers may press the foil strip to at least a part of the rounding of the corner even without displacing the rollers in the transverse direction in relation to the conveying direction. The possible remaining part of the rounding of the corner may be foiled when the plate has been rotated 90 degrees and is conveyed along the rollers again.

In an embodiment, subsequently to providing the first edge of the plate and at least 50 percent of the rounding of the corner with the first foil strip, the second edge of the platen and at least 50 percent of the rounding of the corner is provided with a second foil strip.

In an embodiment, the first foil strip and the second foil strip are provided onto the corner so that they overlap each other by at least 5 percent, preferably by at least 10 percent, and most preferred by at least 15 percent, of the rounding of the corner. Thereby, it may be ensured the foil is applied continuously around the corners and a smooth finish around the corners may be ensured.

In an embodiment, the foil strip is provided in a so-called hot-foiling process.

In an embodiment, the following steps are performed in succession:
a) two first opposed edges of a plate are provided with an edge profile by means of two respective rotating edge milling tools,
b) four corners of the plate are rounded by means of four respective rotating corner milling tools,
c) the two first opposed edges are provided with a layer of lacquer by means of two respective lacquer application rollers, when each of the lacquer application rollers is at a position at a corner, the peripheral speed of said lacquer application roller is changed in relation to the velocity of the plate in the conveying direction so that an extra amount of lacquer is deposited at said corner, so that each one of the four corners receive an extra amount of lacquer,
d) said lacquer is at least partially cured,
e) the four corners of the plate are at least partly grinded by means of four respective rotating corner guiding tools,

f) the two first opposed edges of the plate and at least part of the rounding of each of the four corners of the plate are provided with a first foil strip,
g) the plate is rotated 90 degrees in relation to the conveying direction so that the plate is now conveyed with its two first opposed edges as a leading edge and a trailing edge, respectively;
h) two second opposed edges of the plate are provided with an edge profile by means of the two respective rotating edge milling tools,
i) the two second opposed edges are provided with a layer of lacquer by means of the two respective lacquer application rollers, when each of the lacquer application rollers at a position at a corner; the peripheral speed of said lacquer application roller is changed so relation to the velocity of the plate in the conveying direction so that an extra amount of lacquer is deposited at said corner, so that each one of the four corners receive an extra amount of lacquer,
j) said lacquer is at least partially cured,
k) the four coolers of the plate are at least partly grinded by means of the four respective rotating corner grinding tools, and
l) the two second opposed edges of the plate and at least part of the rounding of each of the four corners of the plate are provided wish a second foil strip so that the second foil strips overlap the first foil strips at the corners.

The steps c), d) and e) are preferably repealed once in succession so that firstly, a base lacquer is applied, cured and grinded at corners, and subsequently a top lacquer is applied, cured and grinded at corners. Possibly, grinding at corners just after applying the base lacquer may be omitted so that grinding at corners is only performed after the top lacquer.

Furthermore, it is noted that preferably, edges are belt-sanded after step a) and after each step of providing a layer of lacquer. Moreover, when lacquer has been provided, a top and bottom face of the plate is scraped at the transition of the edge profile of the plate in order to remove excess lacquer. The curing steps d) are preferably performed by UV light. Before application of a foil strip, the edges may be polished for instance by means of Scotch-Brite (registered trade mark). In the case of hot-foiling, the edges may be heated by means of IR light before application of the foil strip.

The present invention further relates to a continuous edge processing device for edge processing of plates, including a conveyor for continuous conveyance of plates in a conveying direction and a rotatable edge milling tool having a peripheral profile corresponding to a desired edge profile of a plate and being adapted to provide at least a first edge of a plate with an edge profile.

The continuous edge processing device is characterised in that a rotatable corner milling tool having a peripheral profile corresponding to a desired corner edge profile of the plate is adapted to round at least a corner connecting the first edge and a second edge of the plate, in that the rotatable corner milling tool is arranged displaceably in the conveying direction and in a transverse direction to the conveying direction, in that a position and/or a velocity detection device is adapted to continuously detect the position and/or velocity of the plate in the conveying direction, and in that a control unit is adapted to, on the basis of the defected position and/or velocity or the plate control the position of the rotatable corner milling tool to follow a trajectory describing at least a part of a desired rounding of the corner a coordinate system fixed to the continuously moving plate. Thereby, the above described features may be obtained.

In an embodiment the control unit is adapted to control the rotatable corner milling tool to be displaced along the continuously moving plate so that the rotatable corner milling tool moves next to a corner to be rounded, and to subsequently control the rotatable corner milling tool to be displaced simultaneously in the conveying direction and in a transverse direction to the conveying direction so that the rotatable corner milling tool follows said trajectory. Thereby, the above described features may be obtained.

In an embodiment, the control unit is adapted to calculate said trajectory as an estimated trajectory on the basis of the velocity of the plate in the conveying direction at a position of the plate in the conveying direction before the control unit starts to control the rotatable corner milling tool to follow said trajectory. Thereby, the above described features may be obtained.

In an embodiment, a first tachometer coupled to the conveyor is adapted to determine the velocity of the plate in the conveying direction. Thereby, the above described features may be obtained.

In an embodiment, the control unit is adapted to calculate the trajectory of the rotatable corner milling tool on the basis of a detection of the velocity of the plate in the conveying direction performed when a leading or trailing edge of the plate is detected at a certain position in the conveying direction. Thereby, the above described features may be obtained.

In an embodiment, a first laser detection device is adapted to detect the leading or trailing edge of the plate at said certain position in the conveying direction. Thereby, the above described features may be obtained.

In an embodiment, arranged following the rotatable corner milling tool in the conveying direction, a lacquer application roller having a peripheral profile corresponding at least substantially to the desired edge profile of the plate is adapted to roll on the first edge of the plate, the control unit is adapted to control the lacquer application roller so that it, over at least almost the entire length of the first edge, rolls on the first edge of the plate with a peripheral speed corresponding at least substantially to the velocity of the plate in the conveying direction, and so that when the lacquer application roller is at a position at the corner connecting the first edge and the second edge of the plate, the peripheral speed of the lacquer application roller is changed in relation to the velocity of the plate in the conveying direction so that an extra amount of lacquer is deposited at said corner. Thereby, the above described features may be obtained.

In an embodiment, the control unit is adapted to control the lacquer application roller so that, when the lacquer application roller is at a position at the corner connecting the first edge and the second edge of the plate the peripheral speed of the lacquer application roller is changed to differ by between 2 and 25 percent, preferably by between 3 and 25 percent, more preferred by between 4 and 16 percent, even more preferred by between 6 and 12 percent, and most preferred by between 7 and 10 percent, in relation to the velocity of the plate in the conveying direction. Thereby, the above described features may be obtained.

In an embodiment, the control unit is adapted to control the lacquer application roller so that, if the second edge is a leading edge of the plate, when the lacquer application roller is at a position at the corner connecting the first edge and the second edge of the plate, the peripheral speed of the lacquer application roller is decreased in relation to the velocity of the plate in the conveying direction and it the second edge is a trailing edge of the plate, when the lacquer application roller is at a position at the corner connecting the first edge and the second edge of the plate, the peripheral speed of the lacquer application roller is increased in relation to the velocity of the plate in the conveying direction. Thereby, the above described features may be obtained.

In an embodiment, arranged following: the lacquer application roller in the conveying direction, a rotatable corner grinding tool having a peripheral profile corresponding to the desired corner edge profile of the plate is adapted to grind at least the corner connecting the first edge and a second edge of the plate, in that the rotatable corner grinding tool is arranged displaceably in the conveying direction and in a transverse direction to the conveying direction, in that a further position and/or a velocity detection device is adapted to continuously detect the position and/or velocity of the plate in the conveying direction, and in that a control unit is adapted to, on the basis of the detected position and/or velocity of the plate, control the position of the rotatable corner grinding tool to follow a trajectory describing at least a part of the desired rounding of the corner in a coordinate system fixed to the continuously moving plate. Thereby, the above described features may be obtained.

In an embodiment the control unit is adapted to control the rotatable corner grinding tool to be displaced along the continuously moving plate so that the rotatable corner grinding tool moves next to a corner to be grinded, and to subsequently control the rotatable corner grinding tool to be displaced simultaneously in the conveying direction and in a transverse direction to the conveying direction so that the rotatable corner grinding tool follows said trajectory. Thereby, the above described features may be obtained.

In an embodiment, the control unit is adapted to calculate said trajectory as an estimated trajectory on the basis of the velocity of the plate in the conveying direction at a position of the plate in the conveying direction before the control unit starts to control the rotatable corner grinding tool to follow said trajectory. Thereby, the above described features may be obtained.

In an embodiment, a second tachometer is coupled to the conveyor at a position after the position of the first tachometer in the conveying direction. Thereby, the above described features may be obtained.

In an embodiment, the control unit adapted to calculate the trajectory of the rotatable corner grinding tool on the basis of a detection of the velocity of the plate in the conveying direction performed when a leading or trailing edge of the plate is detected at a certain position in the conveying direction. Thereby, the above described features may be obtained.

In an embodiment, a second laser detection device located at a position after the position of the first laser detection device in the conveying direction is adapted to detect the leading or trailing edge of the plate at said certain position in the conveying direction. Thereby, the above described features may be obtained.

In an embodiment, following the rotatable corner grinding tool in the conveying direction, a foil strip application unit is arranged, and the control unit is adapted to control the foil strip application unit to provide the first edge of the plate and at least 50 percent of the rounding of the corner connecting the first edge and the second edge of the plate with a first foils trip. Thereby, the above described features may be obtained.

In an embodiment, the foil strip application unit includes a number of rollers having an elastic surface and being adapted to press the first foil strip onto the first edge of the plate and part of the rounding of the corner. Thereby, the above described features may be obtained.

In an embodiment, the control unit is adapted to control the foil strip application unit to, in a second pass of the plate through the foil strip application unit, provide a second foil strip onto the corner so that it overlaps the first foil strip by at least 5 percent, preferably by at least 10 percent, and most preferred by at least 15 percent, of the rounding of the corner. Thereby, the above described features may be obtained.

In an embodiment, the foil strip application unit is a so-called hot-foiling application unit. Thereby, the above described features may be obtained.

The invention will now be explained in more detail below by means of examples of embodiments with reference to the very schematic drawing, in which

FIG. 1 is a top view of a corner milling unit according to the invention;

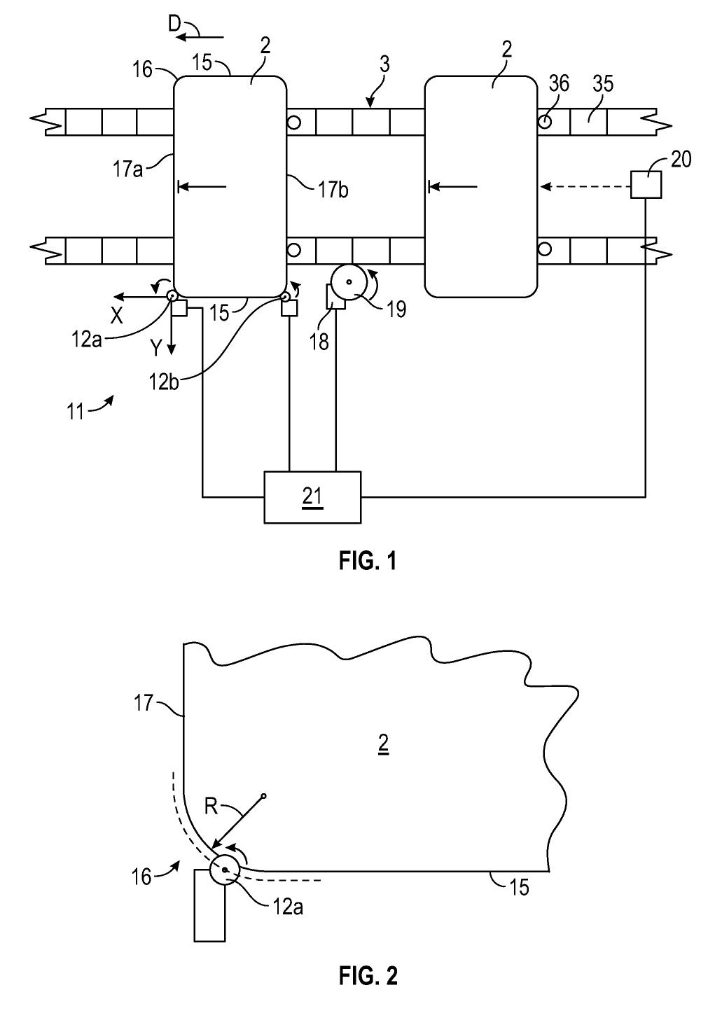

FIG. 2 is a detail of FIG. 1 on a larger scale;

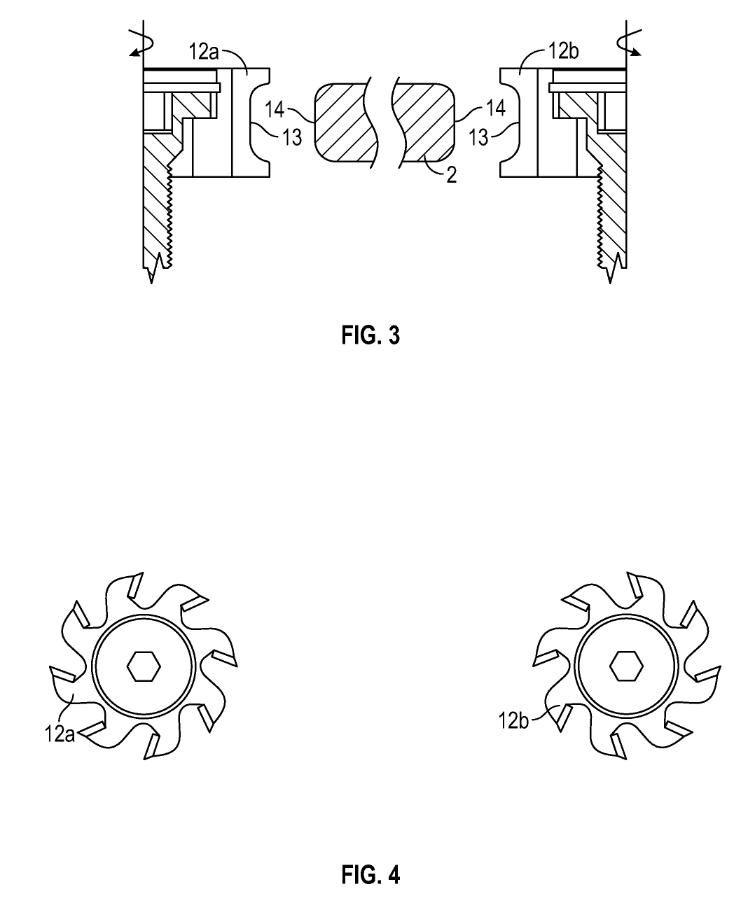

FIG. 3 is a cross-sectional view through opposed rotatable corner milling tools;

FIG. 4 is a top view of the opposed rotatable corner milling tools of FIG. 3;

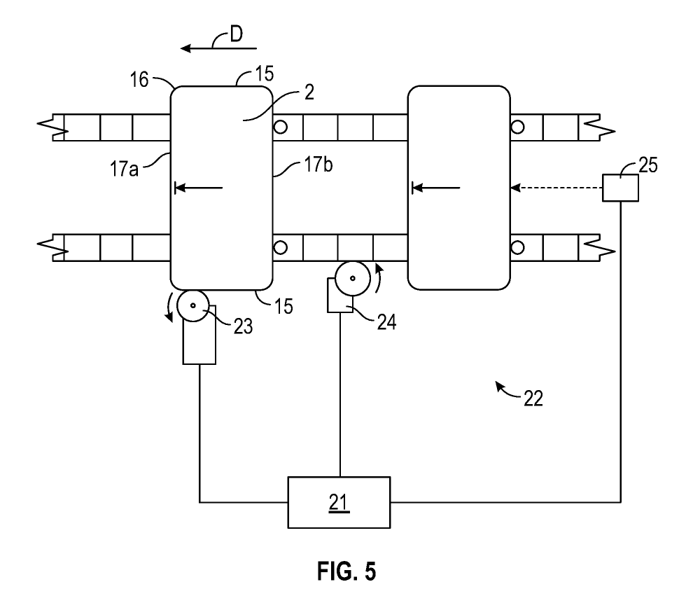

FIG. 5 is a top view of a lacquer application unit according to the invention;

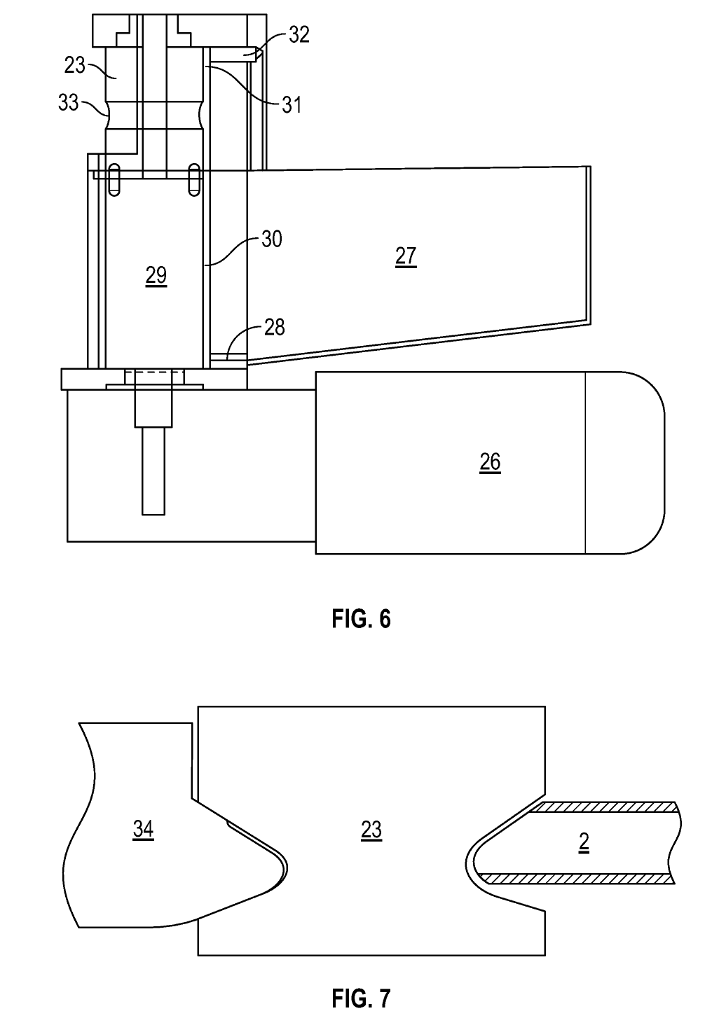

FIG. 6 is a side view of part of the a lacquer application unit of FIG. 5;

FIG. 7 is a cross-sectional view through a lacquer application roller of the lacquer application unit of FIG. 5;

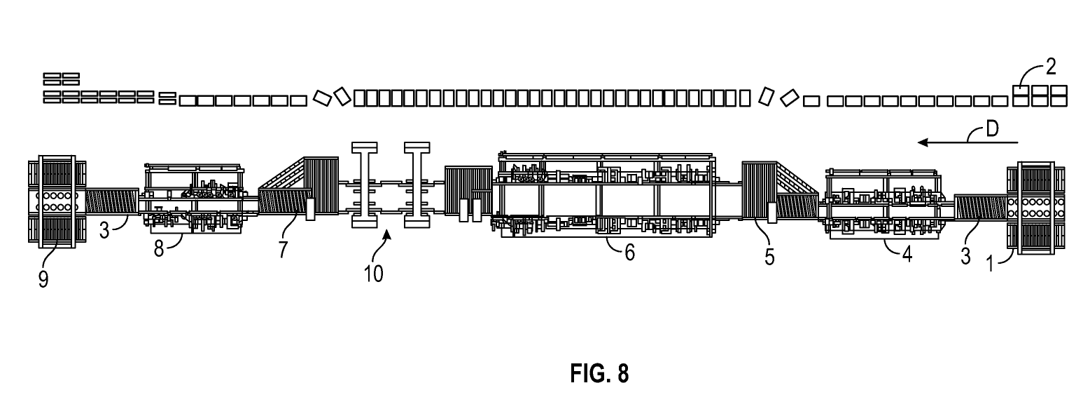

FIG. 8 is a top view of a complete continuous edge processing line with illustration of actual plate orientation in the top part the figure.

FIG. 8 illustrates a complete continuous edge processing line including a continuous edge processing device for edge processing of plates according to the present invention.

The continuous edge processing device according to the present invention may process any kind of plates or lists in order to provide these items with an edge profile along a longitudinal edge and around a corner of the items. Preferably, the same edge profile is provided along the longitudinal edge and around the corner; however, the profiles may differ. The complete continuous edge processing line illustrated in FIG. 8 is suitable to edge process plates in order to provide those with an edge profile along all sides and corners.

Any kind of plates may be processed to the complete continuous edge processing line illustrated in FIG. 8; however, the line is specifically suitable for processing porous materials, such as e.g. MDF plates (MDF=Medium Density Fibreboard), HDF (High Density Fibreboard), masonite, chipboard etc. These types of plates may in particular have edges which may be difficult to provide with a correct edge lacquering.

The continuous edge processing device includes a loading unit 1 in which plates 2 to be processed are loaded on a conveyor 3 for continuous conveyance of the plates in a conveying direction D, a first pass unit 4 in which opposed first sides of the plates are processed, a first turning unit 5 in which the plates are rotated 90 degrees, a second pass unit 6 in winch opposed second sides of the plates are processed, a drilling unit 10 for drilling holes in the plates a second turning unit 7 in which the plates are rotated 90 degrees, a third pass unit 3 in which opposed first sides of the plates are processed once again, and an unloading unit 9 in which the processed plates 2 are unloaded from the conveyor 3. The conveyor 3 may be of the type including chains 35 running precisely on bearings and having upstanding taps 36 which the trailing edge of the plates may abut.

Each of the first pass unit 4, the second pass unit 6 and the third pass unit 8 includes at least some of the stations listed below. These stations may also be provided in one single processing line in the listed sequence. The plates may then pass the single processing line three times (three passes).

The stations are:

1. edge milling unit

2. corner milling unit

3. belt-sanding unit

4 base lacquer unit

5. UV-hardening (curing)

6. scraping at transition between edges and top/bottom face of plates

7. belt-sanding unit (possibly more units in succession)

8. top lacquer unit

9. UV-hardening (curing)

10. scraping at transition between edges and top/bottom face of plates

11. corner grinding unit

12. belt-sanding unit (possibly more units in succession)

13. polishing (possibly oscillating)

14. IR heating of edges

15. foil strip application unit (with elastic silicone rubber rollers)

16. scraping foil strip at transition between edges and top/bottom face of plates

FIG. 1 illustrates a corner milling 11 of the continuous edge processing device according to the invention. The corner milling unit 11 includes the conveyor 3 for continuous conveyance of plates 2 in the conveying direction D. Before the corner milling unit 11, a not shown edge milling unit is arranged. The edge milling unit includes rotatable edge milling tools 12a, 12b having a peripheral profile 13 corresponding to a desired edge profile of the plate 2 and being adapted to provide opposed first edges 15 of the plate 2 with an edge profile. The rotatable edge milling tools 12a, 12b are illustrated in FIGS. 3 and 4. It is seen that the rotatable edge milling tools 12a, 12b include the peripheral profile 13 and milling teeth.

Referring to FIGS. 1 and 2, the rotatable corner milling tools 12a, 12b having the peripheral profile 13 corresponding to a desired corner edge profile 14 of the plate 2 are adapted to round each corner 16 connecting a first edge 15 and a second edge 17 of the plate 2. The rotatable corner milling tools 12a, 12b are arranged displaceably in the conveying direction D along an X axis as illustrated in FIG. 1 and in a transverse direction to the conveying direction along a Y axis as also illustrated in FIG. 1. Although only two rotatable corner milling fools 12a, 12b are illustrated in the figure along one of the opposed first edges 15, preferably there is furthermore arranged two rotatable corner milling tools along the other one of the opposed first edges 15, so all corners 16 of the plate 2 may be rounded at least substantially simultaneously.

A first tachometer 18 is coupled to the conveyor 3 and is adapted to determine the velocity of the plate 2 in the conveying direction D. The first tachometer 18 includes a roller 19 adapted to roll directly on the plate-carrying surface of the conveyor 3 in order to determine the actual velocity very accurately.

A first laser detection device 20 is adapted to detect the leading edge 17a or trailing edge 17b of the plate 2 at a certain position in the conveying direction D.

A control unit 21 is adapted to, on the basis of the position detected by means of the first laser detection device 20 and the actual velocity of the plate 2 determined by the first tachometer 18, control the position of the rotatable corner milling tools 12a, 12b to follow a trajectory describing a desired rounding of the corner is in a coordinate system fixed to the continuously moving plate 2. In FIG. 2, the desired rounding of the corner 16 is illustrated as having a rounding radius R, which may for instance be 1 to 5 millimetres and may preferably be for instance approximately 3 millimetres.

Preferably, the control unit 21 is adapted to calculate the trajectory of the rotatable corner milling tool 12a, 12b on the basis of a detection of the velocity of the plate 2 in the conveying direction D performed by the first tachometer 18 in the moment when a leading or trailing edge 17a, 17b of the plate 2 is detected by the first laser defection device 20 at a certain position in the conveying direction D.

Preferably, the control unit 21 is adapted to control the rotatable corner milling tools 12a, 12b to be displaced along the continuously moving plate 2 so that the rotatable corner milling tools 12a, 12b move next to respective corners 16 to be rounded, and to subsequently control the rotatable corner milling tools 12a, 12b to be displaced simultaneously in the conveying direction D(X) and in a transverse direction (Y) to the conveying direction D so that the rotatable corner milling tools 12a, 12b follow said trajectory.

Preferably, the control unit 21 is adapted to calculate said trajectory as an estimated trajectory on the basis of the velocity of the plate 2 in the conveying direction D at a position of the plate 2 in the conveying direction D before the control unit 21 starts to control the rotatable corner milling tool 12a, 12b to follow said trajectory.

FIG. 5 illustrates a lacquer application unit 22 of the continuous edge processing device according to the invention. The lacquer application unit 22 is arranged following the corner milling unit 11 illustrated in FIG. 1 in the conveying direction D and includes two opposed lacquer application rollers 23 having a peripheral profile corresponding at least substantially to the desired edge profile 14 of the plate 2. The opposed lacquer application rollers 23 of which only one is shown are arranged at either one of the opposed first edges 15 of the plate 2 and are adapted to roll on the first edges 15 of the plate 2.

The control unit 21 is adapted to control the lacquer application rollers 23 so that they, over at least almost the entire length of the first edges 15, roll on the respective first edges of the plate 2 with a peripheral speed corresponding at least substantially to the velocity of the plate 2 in the conveying direction D, and so that when a lacquer application roller 23 is at a position at the corner 16 connecting the first edge 15 and the second edge 17a, 17b of the plate 2, the peripheral speed of the lacquer application roller 23 is changed in relation to the velocity of the plate 2 in the conveying direction D so that an extra amount of lacquer is deposited at said corner 16. This may preferably be achieved in that the control unit 21 is adapted to control each lacquer application roller 23 so that, if the second edge is a leading edge 17a of the plate 2, when the lacquer application roller 23 is at a position at the corner 16 connecting the first edge 15 and the second edge 17 of the plate 2, the peripheral speed of the lacquer application roller 23 is decreased in relation to the velocity of the plate 2 in the conveying direction D, and if the second edge is a trailing edge 17b of the plate 2, when the lacquer application roller 23 is at a position at the corner 16 connecting the first edge 15 and the second edge 17 of the plate 2, the peripheral speed of the lacquer application roller 23 is increased in relation to the velocity of the plate 2 in the conveying direction D.

The control unit 21 may be adapted to control each lacquer application roller 23 so that, when the lacquer application roller 23 is at a position at the corner 16 connecting the first edge 15 and the second edge 17 of the plate 2, the peripheral speed of the lacquer application roller 23 is changed to differ by between 2 and 25 percent, preferably by between 3 and 25 percent, more preferred by between 4 and 16 percent, even more preferred by between 5 and 12 percent, and most preferred by between 7 and 10 percent, in relation to the velocity of the plate 2 in the conveying direction D. For instance, the velocity of the plate 2 in the conveying direction D may be 25 metres per minute and the lacquer application roller 23 may be controlled to have a peripheral speed of 23 metres per minute at a corner 16 at the leading edge 17a and to have a peripheral speed of 27 metres per minute at a corner 16 at the trailing edge 17b.

The control unit 21 is adapted to control the position and speed of each lacquer application roller 23 on the basis of velocity provided by on the basis of a detection of the velocity of the plate 2 in the conveying direction D performed by a separate second tachometer 24 and on the basis of position detected by a separate second laser detection device 25. Other velocity and/or position detection devices may be applied.

In an embodiment, the lacquer application unit 22 illustrated in FIG. 5 further includes the components illustrated in FIGS. 6 and 7. A drive unit 26 may be a motor unit which is frequency-controlled or controlled in another manner and transfers its driving power by means of a transmission unit. A lacquer reservoir 27 contains .he lacquer which is to be applied to the edges 15, 17, said lacquer being led through a lacquer supply channel 28 to a lacquer friction transport roller 29 which forms the innermost part of a lowermost lacquer friction chamber 30, which at a distance between the transport roller 29 and an outer wall in the friction chamber, said distance being dependent on the viscosity of the lacquer used for the relevant item, permits transport of lacquer, preferably highly-viscous acrylic lacquer, via a substantially upwardly winding feed channel, which by pre-processing is formed in the outer wall of the friction chamber 30 up to an uppermost pressure chamber 31, the main lacquer pressure chamber. In a preferred embodiment, the low-friction transport roller is configured in steel and with a smooth surface. Uppermost in the main lacquer pressure chamber 31 there is a lacquer over-pressure channel 32 which ensures that the lacquer has a uniform pressure in the main pressure chamber, and that excess lacquer is re-circulated to the lacquer reservoir 27. The lacquer application roller 23 is placed on the same axle as the transport roller 2S. The cylindrical surface of this lacquer application roller 23 corresponds in profile 33 at least substantially to that edge 15, 17 to which the lacquer is to be applied, so that the profile 33 in the roller is adapted to a CAD reference profile of the item's processed edge 15, 17. For the transfer of the lacquer to the lacquer application roller 23, there is constructed an edge profile lacquer dosing unit 34 illustrated in FIG. 7, where in the ideal case the CAD reference of this dosing profile 34 is identical with the edge profile groove in the lacquer application roller 23. In cases which cannot be considered as being ideal, compensation is made by changing the CAD reference profile or the roller, on the dosing unit or on them both. Such cases are, for example, when lacquer is to be applied to a porous plate, e.g. chipboard edge. Since a part of the lacquer will be absorbed in the core layer, the surface will not be covered uniformly.

Arranged following the lacquer application unit 22 in the conveying direction, a not shown corner grinding unit is arranged in order to grind corners provided with lacquer. Because an extra amount of lacquer has been deposited at the corners 16 by means of the lacquer application roller 23 of the lacquer application unit 22, when the lacquer has been at least partly cured in a not shown curing unit, the layer of lacquer on the corner may be uneven to a certain extent. Therefore, in the not shown corner grinding unit, the layer of lacquer at the corners may be grinded by means of a rotatable corner grinding tool having a peripheral profile corresponding to the desired corner edge profile of the plate. The rotatable corner grinding tool is arranged displaceably in the conveying direction and in a transverse direction to the conveying direction.

The not shown rotatable corner grinding tool has a peripheral profile corresponding to the desired corner edge profile of the plate 2 just as the rotatable edge milling tools 12a, 12b illustrated in FIGS. 3 and 4. However, whereas the rotatable edge milling tools 12a, 12b include milling teeth, the rotatable corner grinding tool does not include teeth, but a peripheral profile provided with suitable grinding properties.

A not shown third tachometer is coupled to the conveyer 3 and is adapted to determine the velocity of the plate 2 in the conveying direction D. The third tachometer includes a roller adapted to roll directly on the plate-carrying surface of the conveyor 3 in order to determine the actual velocity very accurately.

A not shown third laser detection device is adapted to detect the leading edge 17a or trailing edge 17b of the plate 2 at a certain position in the conveying direction D.

The control unit 21 is adapted to, on the basis of the position detected by means of the third laser detection device and the actual velocity of the plate 2 determined by the third tachometer, control the position of the rotatable corner grinding tools to follow a trajectory describing at least a part of the desired rounding of the corner 16 in a coordinate system fixed to the continuously moving plate 2.

Preferably, the control unit 21 is adapted to calculate the trajectory of the rotatable corner grinding tool on the basis of a detection of the velocity of the plate 2 in the conveying direction D performed by the third tachometer in the moment when a leading or trailing edge 17a, 17b of the plate 2 is detected by the third laser detection device at a certain position in the conveying direction D.

Preferably, the control unit 21 is adapted to control the rotatable corner grinding tools to be displaced along the continuously moving plate 2 so that the rotatable corner grinding tools move next to respective corners 16 to be rounded, and to subsequently control the rotatable corner grinding tools to be displaced simultaneously in the conveying direction D and in a transverse direction to the conveying direction D so that the rotatable corner grinding tools follow said trajectory.

Preferably, the control unit 21 is adapted to calculate said trajectory as an estimated trajectory on the basis of the velocity of the plate 2 in the conveying direction D at a position of the plate 2 in the conveying direction D before the control unit 21 starts to control the rotatable corner grinding tool to follow said trajectory.

It may be preferred to control the position of the rotatable corner grinding tools to follow a trajectory describing only a certain part of the desired rounding of the corner 16, whereby said certain part of the desired rounding is next to the first edge 15 of the plate 2. Thereby, the remaining part of the desired rounding next to the second edge 17 may be grinded in a following pass, in which the plate has been rotated 90 degrees and the second edges 17 together with said remaining part of the desired rounding of the corner 16 have been provided with lacquer.

Following the not shown rotatable corner grinding unit in the conveying direction D, a not shown foil strip application unit is arranged wherein the control unit 21 is adapted to control the foil strip application unit to provide the first edges 15 of the plate 2 and at least 50 percent of the rounding of the corner 16 connecting the first edge 15 and the second edge 17a, 17b of the plate 2 with a first foil strip. The foil strip application unit includes a number of rollers having an elastic surface and being adapted to press the first foil strip onto the first edge 15 of the plate 2 and part of the rounding of the corner 16.

The control unit is adapted to control the foil strip application unit to, in a second pass of the plate 2 through the foil stop application unit, provide a second foil strip onto the corners 16 so that it preferably overlaps the first foil strip by at least 5 percent, preferably by at least 10 percent, and most preferred by at least 15 percent, of the rounding of the corner 16. The foil strip application unit may preferably be a so-called hot-foiling application unit.

It is noted that rounding of the corners of the plates according to the present invention not only provided a desired smooth finish, but may also facilitate foil strip application at the corners in that the foil strip may overlap which is not possible at conventionally processed sharp corners.

1. A method of continuous edge processing of plates (2), whereby the plates are conveyed continuously in a conveying direction (D), and whereby at least a first edge (15) of a plate (2) is provided with an edge profile by means of a rotating edge milling tool having a peripheral profile corresponding to a desired edge profile of the plate, characterised by that at least a corner (16) connecting the first edge (15) and a second edge (17) of the plate (2) rounded at least partly by means of a rotating corner milling tool (12a, 12b) having a peripheral profile (13) corresponding to a desired corner edge profile of the plate, by that the rotating corner milling tool (12a, 12b) is controlled to be displaced along the continuously moving plate (2) so that the rotating corner milling tool (12a, 12b) moves next to a corner (16) to be rounded, and by that the rotating corner milling tool (12a, 12b) subsequently controlled to be displaced simultaneously in the conveying direction (D) and in a transverse direction to the conveying direction so that the rotating corner milling tool follows a trajectory describing at least a part of a desired rounding of the corner (16) coordinate system fixed to the continuously moving plate.

2. A method of continuous edge processing according to claim 1, whereby a control unit (21) controls displacement of the rotating corner milling tool (12a, 12b) in the conveying direction (D) and in a transverse direction to the conveying direction, whereby a position and/or velocity detection device continuously detects the position and/or velocity of the plate in the conveying direction, and whereby the control unit, on the basis of the detected position and/or velocity of the plate, controls the position of the rotating corner milling tool to follow said trajectory.

3. A method of continuous edge processing according to claim 1 or 2, whereby the control unit (21) calculates said trajectory as an estimated trajectory on the basis of the velocity of the plate (2) in the conveying direction at a position of the plate in the conveying direction before the control unit starts to control the rotating corner milling tool to follow said trajectory.

4. A method of continuous edge processing according to claim 3, whereby the velocity of the plate in the conveying direction is determined by means of a first tachometer (18) coupled to a conveyor continuously conveying the plates in the conveying direction.

5. A method of continuous edge processing according to claim 3 or 4, whereby the velocity of the plate in the conveying direction is determined when a leading or trailing edge of the plate is detected at a certain position in the conveying direction.

6. A method of continuous edge processing according to claim 5, whereby the leading or trailing edge of the plate is detected at said certain position by means of a first laser detection device (20).

7. A method of continuous edge processing according to any one of the preceding claims, whereby subsequently to rounding the corner (16) connecting the first edge (15) and the second edge (17) of the plate (2), the first edge is provided with a layer of lacquer by means of a lacquer application roller (23) having a peripheral profile corresponding at least substantially so the desired edge profile of the plate, whereby the lacquer application roller, over at least almost the entire length of the first edge, rolls on the first edge of the plate with a peripheral speed corresponding at least substantially to the velocity of the plate in the conveying direction, and whereby, when the lacquer application roller is at a position at the corner connecting the first edge and the second edge of the plate, the peripheral speed of the lacquer application roller is changed in relation to the velocity of the plate in the conveying direction so that an extra amount of lacquer is deposited at said corner.

8. A method of continuous edge processing according to claim 7, whereby, when the lacquer application roller (23) is at a position at the corner connecting the first edge and the second edge of the plate, the peripheral speed of the lacquer application roller is changed to differ by between 2 and 25 percent, preferably by between 3 and 25 percent, more preferred by between 4 and 16 percent, even more preferred by between 6 and 12 percent, and most preferred by between 7 and 10 percent, in relation to the velocity of the plate in the conveying direction.

9. A method of continuous edge processing according to claim 7 or 8, whereby, if the second edge is a leading edge of the plate, when the lacquer application roller (23) is at a position at the corner (16) connecting the first edge and the second edge of the plate, the peripheral speed of the lacquer application roller is decreased in relation to the velocity of the plate in the conveying direction, and if the second edge is a trailing edge of the plate, when the lacquer application roller is at a position at the corner connecting the first edge and the second edge of the plate, the peripheral speed of the lacquer application roller is increased in relation to the velocity of the plate in the conveying direction.

10. A method of continuous edge processing according to any one of the claims 7 to 9, whereby, subsequently to application of lacquer at the corner (16) connecting the first edge and the second edge of the plate, and subsequently to an at least partial curing of said lacquer, said corner is grinded by means of a rotating corner grinding tool having a peripheral profile corresponding to the desired corner edge profile of the plate, by that the rotating corner grinding tool is controlled to be displaced along the continuously moving plate so that the rotating corner grinding tool moves next to said corner, and by that the rotating corner grinding tool is subsequently controlled to be displaced simultaneously in the conveying direction and in a transverse direction to the conveying direction so that the rotating corner grinding tool follows a trajectory describing at least a part of the desired rounding of the corner in a coordinate system fixed to the continuously moving plate.

11. A method of continuous edge processing according to claim 10, whereby a control unit controls displacement of the rotating corner grinding tool in the conveying direction and in a transverse direction to the conveying direction, whereby a further position and/or velocity detection device continuously detects the position and/or velocity of the plate in the conveying direction, and whereby the control unit, on the basis of the detected position and/or velocity of the plate, controls the position of the rotating corner grinding tool to follow said trajectory.

12. A method of continuous edge processing according to claim 10 or 11, whereby the control unit calculates said trajectory as an estimated trajectory on the basis of the velocity of the plate in the conveying direction at a position of the plate in the conveying direction before the control unit starts to control the rotating corner grinding tool to follow said trajectory.

13. A method of continuous edge processing according to claim 12, whereby the velocity of the plate in the conveying direction is determined by means of a second tachometer coupled to the conveyor at a position after the position of the first tachometer in the conveying direction.

14. A method of continuous edge processing according to claim 12 or 13, whereby the velocity of the plate in the conveying direction is determined when a leading or trailing edge of the plate is detected at a certain position in the conveying direction.

15. A method of continuous edge processing according to claim 14, whereby the leading or trailing edge of the plate is detected at said certain position by means of a second laser detection device located at a position after the position of the first laser detection device in the conveying direction.

16. A method of continuous edge processing according to any one of the claims 10 to 15, whereby, subsequently to grinding said corner by means of a rotating corner grinding tool, the first edge, of the plate and at least 50 percent of the rounding of the corner connecting the first edge and the second edge of the plate is provided with a first foil strip.

17. A method of continuous edge processing according to claim 16, whereby the first foil strip is pressed onto the first edge of the plate and part of the rounding of the corner by means of a number of rollers having an elastic surface.

18. A method of continuous edge processing according to claim 16 or 17, whereby, subsequently to providing the first edge of the plate and at least 50 percent of the rounding of the corner with the first foil strip, the second edge of the plate and at least 50 percent of the rounding of the corner is provided with a second foil strip.

19. A method of continuous edge processing according to claim 18, whereby the first foil strip and the second foil strip are provided onto the corner so that they overlap each other by at least 5 percent preferably by at least 10 percent, and most preferred by at least 15 percent, of the rounding of the corner.

20. A method of continuous edge processing according to any one of the claims 16 to 19, whereby the foil strip is provided in a so-called hot-foiling process.

21. A method of continuous edge processing according to any one of the preceding claims, whereby the following steps are performed in succession:
a) two first opposed edges of a plate are provided with an edge profile by means of two respective rotating edge milling tools,
b) four corners of the plate are rounded by means of four respective rotating corner milling tools,
c) the two first opposed edges are provided with a layer of lacquer by means of two respective lacquer application rollers, whereby, when each of the lacquer application rollers is at a position at a corner, the peripheral speed of said lacquer application roller is changed in relation to the velocity of the plate in the conveying direction so that an extra amount of lacquer is deposited at said corner, so that each one of the four corners receive an extra amount of lacquer,
d) said lacquer is at least partially cured,
e) the four corners of the plate are at least partly grinded by means of four respective rotating corner grinding tools,
f) the two first opposed edges of the plate and al least part of the rounding or each of the four corners of the plate are provided with a first foil strip,
g) the plate is rotated 90 degrees in relations to the conveying direction so that the plate is now conveyed with its two first opposed edges as a leading edge and a trailing edge, respectively;
h) two second opposed edges of the plate are provided with an edge profile by means of the two respective rotating edge milling tools,
i) the two second opposed edges are provided with a layer of lacquer by means of the two respective lacquer application rollers, whereby, when each of the lacquer application rollers is at a position at a corner, the peripheral speed of said lacquer application roller is changed in relation to the velocity of the plate in the conveying direction so that an extra amount of lacquer is deposited at said corner, so that each one of the four corners receive an extra amount of lacquer,
j) said lacquer is at least partially cured,
k) the four corners of the plate are at least partly grinded by means of the four respective rotating corner grinding tools, and
l) the two second opposed edges of the plate and at least part of the rounding of each of the four corners of the plate are provided with a second foil strip so that the second foil strips overlap the first foil strips at the corners.

22. A continuous edge processing device for edge processing of plates, including a conveyor (3) for continuous conveyance of plates (3) in a conveying direction (D) and a rotatable edge milling fool having a peripheral profile corresponding to a desired edge profile of a plate and being adapted to provide at least a first edge of a plate with an edge profile, characterised in that a rotatable corner milling tool (12a, 12b) having a peripheral profile corresponding to a desired corner edge profile of the plate is adapted to round at least a corner (16) connecting the first edge (15) and a second edge (17) of the plate (2), in that the rotatable corner milling tool (12a, 12b) is arranged displaceably in the conveying direction (D) and in a transverse direction to the conveying direction, in that a position and/or a velocity detection device is adapted to continuously detect the position and/or velocity of the plate in the conveying direction, and in that a control unit is adapted to, on the basis of the detected position and/or velocity of the plate, control the position of the rotatable corner milling tool to follow a trajectory describing at least a part of a desired founding of the corner in a coordinate system fixed to the continuously moving plate.

23. A continuous edge processing device according to claim 22, wherein the control unit is adapted to control the rotatable corner milling tool to be displaced along the continuously moving plate so that the rotatable corner milling tool moves next to a corner to be rounded, and to subsequently control the rotatable corner milling tool to be displaced simultaneously in the conveying direction and in a transverse direction to the conveying direction so that the rotatable corner milling tool follows said trajectory.

24. A continuous edge processing device according to claim 22 or 23, wherein the control unit is adapted to calculate said trajectory as an estimated trajectory on the basis of the velocity of the plate in the conveying direction at a position of the plate in the conveying direction before the control unit starts to control the rotatable corner milling tool to follow said trajectory.

25. A continuous edge processing device according to any one the claims 22 to 24, wherein a first tachometer coupled to the conveyor is adapted to determine the velocity of the plate in the conveying direction.

26. A continuous edge processing device according to any one of the claims 22 to 25, wherein the control unit is adapted to calculate the trajectory of the rotatable corner milling tool on the basis of a detection of the velocity of the plate in the conveying direction performed when a leading or trailing edge of the plate is detected at a certain position in the conveying direction.

27. A continuous edge processing device according to claim 28, wherein a first laser detection device is adapted to detect the leading or trailing edge of the plate at said certain position in the conveying direction.

28. A continuous edge processing device according to any one of the claims 22 to 27, wherein, arranged following the rotatable corner milling tool in the conveying direction, a lacquer application roller (23) having a peripheral profile corresponding at least substantially to the desired edge profile of the plate is adapted to roll on the first edge of the plate, wherein the control unit (21) is adapted to control the lacquer application roller so that it, over at least almost the entire length of the first edge, rolls on the first edge of the plate with a peripheral speed corresponding at least substantially to the velocity of the plate in the conveying direction, and so that when the lacquer application roller is at a position at the corner connecting the first edge and the second edge of the plate, the peripheral speed of the lacquer application roller is changed in relation to the velocity of the plate in the conveying direction so that an extra amount of lacquer is deposited at said corner.

29. A continuous edge processing device according to claim 28, wherein the control unit is adapted to control the lacquer application roller so that, when the lacquer application roller is at a position at the corner connecting the first edge and the second edge of the plate, the peripheral speed of the lacquer application roller is changed to differ by between 2 and 25 percent, preferably by between 3 and 25 percent, more preferred by between 4 and 18 percent, even more preferred by between 6 and 12 percent, and most preferred by between 7 and 10 percent, in relation to the velocity of the plate in the conveying direction.

30. A continuous edge processing device according to claim 23 or 23, wherein the control unit is adapted to control the lacquer application roller so that, if the second edge is a leading edge of the plate, when the lacquer application roller is at a position at the corner connecting the first edge and the second edge of the plate, the peripheral speed of the lacquer application roller is decreased in relation to the velocity or the plate in the conveying direction, and if the second edge is a trailing edge of the plate, when the lacquer application roller is at a position at the corner connecting the first edge and the second edge of the plate, the peripheral speed of the lacquer application roller is increased in relation to the velocity of the plate in the conveying direction.

31. A continuous edge processing device according to any one of the claims 28 to 30, wherein, arranged following the lacquer application roller in the conveying direction, a rotatable corner grinding tool having a peripheral profile corresponding to the desired corner edge profile of the plate is adapted to grind at least the corner connecting the first edge and a second edge of the plate, in that the rotatable corner grinding tool is arranged displaceably in the conveying direction and in a transverse direction to the conveying direction, in that a further position and/or a velocity detection device is adapted to continuously detect the position and/or velocity of the plate in the conveying direction, and in that a control unit is adapted to or the basis of the detected position and/or velocity of the plate, control the position of the rotatable corner grinding tool to follow a trajectory describing at least a part of the desired rounding of the corner in a coordinate system fixed to the continuously moving plate.

32. A continuous edge processing device according to claim 31, wherein the control unit is adapted to control the rotatable corner grinding tool to be displaced along the continuously moving plate so that the rotatable corner grinding tool moves next to a corner to be grinded, and to subsequently control the rotatable corner grinding tool to be displaced simultaneously in the conveying direction and in a transverse direction to the conveying direction so that the rotatable corner grinding tool follows said trajectory.

33. A continuous edge processing device according to claim 31 or 32, wherein the control unit is adapted to calculate said trajectory as an estimated trajectory on the basis of the velocity of the plate in the conveying direction at a position of the plate in the conveying direction before the control unit starts to control the rotatable corner grinding tool to follow said trajectory.

34. A continuous edge processing device according to any one of the claims 31 to 33, wherein a second tachometer is coupled to the conveyer at a position after the position of the first tachometer in the conveying direction.

35. A continuous edge processing device according to any one of the claims 31 to 34, wherein the control unit is adapted to calculate the trajectory of the rotatable corner grinding tool on the basis of a detection of the velocity of the plate in the conveying direction performed when a leading or trailing edge of the plate is defected at a certain position in the conveying direction.

36. A continuous edge processing device according to claim 38, wherein a second laser detection device heated at a position after the position of the first laser detection device in the conveying direction is adapted to detect the leading or trailing edge of the plate at said certain position in the conveying direction.

37. A continuous edge processing device according to any one of the claims 31 to 36, wherein, following the rotatable corner grinding tool in the conveying direction, a foil strip application unit is arranged, and wherein the control unit is adapted to control the foil strip application unit to provide the first edge of the plate and at least 50 percent of the rounding of the corner connecting the first edge and the second edge of the plate with a first foil strip.

38. A continuous edge processing device according to claim 37, wherein the foil strip application unit includes a number of rollers having an elastic surface and being adapted to press the first foil strip onto the first edge of the plate and part of the rounding of the corner.

39. A continuous edge processing device according to claim 37 or 38, wherein the control unit is adapted to control the foil strip application unit to, in a second pass of the plate through the foil strip application unit, provide a second foil strip onto the corner so that it overlaps the first foil strip by at least 5 percent, preferably by at least 10 percent, and most preferred by at least 15 percent, of the rounding of the corner.

40. A continuous edge processing device according to any one of the claims 37 to 39, wherein the foil strip application unit is a so-called hot-foiling application unit.
